(19) United States
(12) Patent Application Publication
(10) Pub. No.: US 2006/0042319 A1
(43) Pub. Date: Mar. 2, 2006

(54) Method for preparing a mineral melt

(75) Inventors: Guido Nykiel, Gladbeck (DE); Andreas Leismann, Bochum (DE)

Correspondence Address: LOCKE LIDDELL & SAPP LLP, 600 TRAVIS, 3400 CHASE TOWER, HOUSTON, TX, 77002-3095, US

(73) Assignee: Rockwool International A/S, Jledehusene (DK)

(21) Appl. No.: 10/534,009

(22) PCT Filed: Nov. 6, 2003
(86) PCT No.: PCT/EP03/12393

§ 371 Date: May 5, 2005

(30) Foreign Application Priority Data
Nov. 6, 2002 (DE) 102 52 000.3
Jun. 6, 2003 (EP) 03253600.5

(51) Int. Cl. C03B 5/16; C03B 37/02

(52) U.S. Cl. 65/134.8; 65/475

(57) ABSTRACT

The invention relates to a method for preparing a mineral melt for mineral fibres production, in particular rock wool used for thermal and/or acoustical insulation or for fire protection, stock culture substrates, reinforcement, and filtering fibres. The inventive method consists in breaking and compacting at least industrial residual materials and correction materials which are used for regulating the required composition and viscosity of the mineral melt with a bonding agent in such a way that moulded pieces can be formed and, afterwards transferred to a melting unit. The aim of said invention is to improve a method for the preparation of a mineral melt for producing rock wool in a low-cost manner optimizing properties of produced mineral fibre articles. For this purpose the components of the moulded pieces, in particular the correction materials and/or other components of a mixture are substituted at least partially by granulated combustion products, in particular ashes or slags produced by combusting lignite and/or coat-dust, waste paper or wood chips.

This invention relates to a method for preparing a mineral melt for the production of mineral fibres, in particular rock wool used for thermal and/or acoustical insulation or for fire protection, substrates for the cultivation of plants, reinforcement fibres and fibres for filtration purposes, in which method at least industrial residual materials as well as correction materials for regulating the required composition and viscosity of the melt are reduced in size and compacted together with a bonding agent to form moulded pieces, and in which said moulded pieces are supplied to a melting unit.

Insulation materials made of rock wool serve for thermal, acoustic and/or fire protection. Rock wool products are further used for the cultivation of plants or for reinforcing for example coating masses or other products or also as fibres for filtering purposes. In the following the rock wool products given as an example are collectively referred to as mineral fibre products.

From prior art methods are known for preparing mineral melts for the production of mineral fibres for thermal and/or acoustic insulation as well as for fire protection. These mineral fibre products consist of vitrously solidified inorganic mineral fibres that are produced with the aid of a melting process. In this melting process suitable raw materials are melted and thereafter the resulting melt is defibred in a defibring unit. Defibring of said melt is effected for example in a so-called drawing, centrifugal or blowing process. In the production of insulating materials or substrates said mineral fibres are wetted with bonding and/or impregnating agents either droplet by droplet or are coated with bonding and/or impregnating agents directly after the defibring, so that thereafter the same may be interconnected point by point. Then the fibre mass treated in this way may be collected, deformed and the resulting structure fixed through the curing of the bonding agents.

Reinforcing fibres and filtering fibres are as rule not treated with bonding and/or impregnating agents.

In commerce glass wool is usually differentiated from rock wool according to the composition of the glass fibres. Rock wool is mainly produced from mixtures of broken extrusive rocks such as basalt or diabase and small amounts of limestone, dolomite and magnesite as additional materials, as well as broken extrusive rocks and lumpy blast furnace slags and, if necessary, additional small amounts of limestone, dolomite and magnesite. These additional materials may be added to the mechanical mixtures either independently or in different mixtures with each other. The broken raw materials are replaced to an increasing extent by artificially produced bodies of a corresponding size, shape and strength, which bodies are composed of various raw and residual materials as well as suitable bonding agents. These bodies are hereinafter referred to as moulded pieces.

Said moulded pieces may contain fine-grained broken natural rocks. Further added components are industrial residual materials, for example the coarser components necessarily produced in the manufacturing process like blowpipe beads, solidified slag occuring during the regular discharging operation of the melting furnaces together with partially fused residual rocks and parts of the furnace lining from fire-resistant construction materials as well as the insulating materials or substrates occuring during the trimming of a continuously produced fibre web. Other industrial residual materials are cuttings, defective products or used insulating materials or substrates to be fused.

Residual materials conditional on the production are prepared for the manufacturing of moulded pieces, i.e. comminuted, ground open and thereafter mixed with correction materials.

With the aid of these correction materials the required composition of the mechanical mixtures is obtained which causes a uniform and rapid fusion within the melting unit. At the same time the temperature and viscosity are thereby influenced to an extent that a defibring process is achieved which takes place as efficiently and uniformly as possible.

Correction materials are for example slags from steel industry such as converter or foundry ladle slags or melting chamber granulates from coal power plants. As essential correction materials are considered also materials which contain aluminium in an oxidic and/or metallic form. Suitable supports are crude bauxite or calcined bauxite as well as alumina melting elements which naturally may also function as a bonding agent. The corresponding utilization of oil industry catalysts which are no longer usable is known from DE 101 02 615 A1.

Correction materials containing both Al₂O₃ and metallic aluminium are the slags described in WO 99/28252 A1 which are produced in the recuperation of aluminium from Al-scrap. These slags still contain among others small amounts of Na-sulphates and Na-fluorides.

Further correction materials are ores like for example haematite (Fe₂O₃) or magnetite (Fe₃O₄).

The granular and fibrous components, the internal residual materials and the correction materials are mainly mixed with inorganic bonding agents, mostly under the addition of water, and are subsequently compacted to form moulded pieces.

Inorganic bonding agents are generally understood to be hydraulically setting cements like standardized Portland cements, but also all kinds of special cements like the already mentioned alumina melting elements. The bonding agent moieties in the moulded pieces amount to approx 9 to 15% by weight.

After having reached a strength that is sufficient for heap storage, conveying and feeding, said moulded pieces which should normally reach a resistance to pressure of approx 3-5 MPa after 3 days for example are fed to the melting unit either together with the other raw materials or alone, however, always together with the lumpy burnables which are necessary for the melting process. Within said melting unit the melt required for the fibre formation is prepared and thereafter fed to the defibring unit. Said defibring unit is normally comprised of several rollers revolving at a high rotational speed and arranged in an offset fashion on top of each other.

The temperature and viscosity of the mineral melt have a considerable influence on the processibility in the respective defibring unit. The optimum processing range of the melt may accordingly be specifically influenced by the selection of the raw materials. In addition, the chemical composition of the melt and of the mineral fibres produced from it has an effect on the biosolubility, i.e. the dwell time in the human organism. The biosolubility results to a decisive extent from the oxide moieties and the compounds of the silicon, aluminium, titanium, sodium, magnesium, potassium, calcium as well as their ratios to each other. For the biosolubility there are important for example also the boroxide moieties.

A typical composition of a mineral melt for the production of commercially available biosoluble rock wool substantially is as follows:

| | |
|---|---|
| SiO₂ | 34.8 to 43% by weight |
| Al₂O₃ | 17.5 to 23.2% by weight |
| TiO₂ | 0 to 2.9% by weight |
| Fe₂O₃ | 2 to 10% by weight |
| CaO + MgO | 23.3 to 31.4% by weight |
| K₂O + Na₂O | 1.3 to 6.9% by weight |
| others | <3% by weight |

Starting from the above-mentioned prior art the invention is based on the problem of improving this kind of a method for preparing a mineral melt for producing rock wool in such a way that the costs of the raw materials are lowered on one side, while the properties of mineral fibre articles to be produced are optimized, if possible, on the other side.

The solution of this problem provides that the components of the moulded pieces, particularly the correction materials and/or other components of the mechanical mixture are at least partially substituted by granular residues of combustion, in particular ashes or slags, preferably from the combustion of lignite and/or coal dust, paper sludge or wood chips.

Accordingly, the invention above all provides that for the production of said moulded pieces the correction materials mixed with the industrial residual materials are partially substituted by residues of combustion.

The compositions of the ashes and slags usually vary within certain limits.

In the fluidized-bed combustion waste materials are burnt in a fluidized bed at a temperature >800° C. For the combustion of low-calorific waste materials fuels are admixed. The fluidized bed is produced by the addition of fluidizing air through a tuyere bottom. Fuel and/or waste materials may be fed to the fluidized bed by means of belt charging from the top onto the fluidized bed or also directly into the fluidized bed by means of worm conveyors. Within said fluidized bed the degassing and gasification of the fuel and the burn-off of the fixed carbon are effected. Volatiles may be afterburnt or the heat recovered by means of heat exchangers. The intense mixing and combustion which is conditional upon the process, the good heat transmission within the fluidized bed as well as the residence time of the hot flue gases allow fluidized-bed ashes to be produced which exhibit a high degree of uniformity regarding the humidity and chemical, mineralogical as well as granuolmetric composition.

Here, directly discharged bed ashes having a diameter d₅₀ of approx 0.3 mm and extra fine-grained filter ashes having a diameter d₅₀ of approx 0.01 mm must be differentiated, which are separated from the flue gases produced in the combustion in electric and fibrous filters. Due to the desulphurization of said flue gases the ashes may contain correspondingly formed compounds.

The same applies to the combustion of lignite and coal dusts as well as wood dusts for yielding energy and for manufacturing processes with frequently or continuously produced low-calorific side products like for example paper sludge burnt in a subsequent step of the process in order to utilize for example the remaining energy or to reduce the volume for later disposal.

In the combustion of fuels, particularly of saliferous coals and waste there are almost regularly added sorbants like for example limestone for direct desulphurization. This results in a concentration of alkaline earth sulphates in the ash. A comparable content of alkaline earth sulphate in the ashes or in the filter residues occurs when the flue gas dust collection is effected by means of downstream dry additive systems.

Due to their chemical composition such filter ashes not only can subsititute a part of the correction materials in the production of moulded pieces but surprisingly can also extremely favourably influence the development of the strength of the moulded pieces. This effect is to be attributed on one side to latent hydraulic properties of some of the mentioned ashes and/or to the catalytic effect on the bonding agents that are used and finally also to their grain sizes. So surprisingly, in the moulded pieces bonded with Portland cement both the early strength and the final strength increase. The final strength is not of any practical importance here. As the early strength is reached very quickly it is, however, possible to shorten the storage time of the moulded pieces before using them. Unless the process requires said early strength to its maximum possible degree, the bonding agent moiety in the moulded pieces may be reduced. Both effects, namely the shorter storage time and/or the reduced bonding agent moieties directly result in lower costs.

In the following there is shown a preferred composition of ash without any absorbent:

| | |
|---|---|
| SiO₂ | 12 to 46% by weight |
| Al₂O₃ | 8 to 20% by weight |
| TiO₂ | 0.2 to 2% by weight |
| Fe₂O₃ | 1 to 11% by weight |
| MgO | 1 to 10% by weight |
| CaO | 8 to 31% by weight |
| K₂O | 1 to 3% by weight |
| Na₂O | 0.2 to 1.5% by weight |
| SO₃ | 2 to 15% by weight |
| others | <2% by weight |

By the use of CaO as an absorbent the CaO-content in such an ash may be increased to 70% and the SO₃-content to 20%. This will correspondingly decrease the moieties of other components.

Further advantages of the inventive use of the ashes are the considerably improved miscibility and formability through the compaction of the materials forming the basis of said moulded pieces, due to the fine-grained structure. In view of the other components of the moulded pieces the grain size distribution of the ashes and the other residual materials yet allow bulk densities to be reached which, being approx 1.4 to approx 1.9 kg/dm³, are relatively high and result in huge final strengths, in co-operation with the bonding agents.

These mass concentrations in the moulded pieces naturally lead to higher efficiencies of the melting units. The high inner strengths of the moulded pieces allow the percentage of abrasion or chipping caused by heap storage, transportation and feeding to the melting units to be kept low. Therefore, it is possible to maintain a high degree of flow through the entire packing in the frequently used shaft furnaces, whereby the melting process takes place uniformly and rapidly. Both effects also have a positive influence on the efficiency of the downstream defibring unit, in particular to a uniform rendering of the fibre forming process.

If the moulded pieces can be handled with great care until they finally arrive in the melting unit, the requirements to the strength may be reduced which is usually done by reducing the bonding agent moieties. Here, potential savings of approx 5 to approx 15% by weight of the normally used bonding agents are possible.

The essential advantages and features of the invention may be summarized as follows:

The above-described combustion residues, particularly ashes and/or slags and preferably filter ashes have chemical compositions which are particularly suited for the correction of the compositions of mineral melts for the production of mineral fibres. At the usual combustion temperatures said combustion residues cause a reduction of the viscosity of the mineral melt. This allows for example the production of finer mineral fibres more uniformly, which fact in turn positively influences the properties of use of the mineral fibres and the mineral fibre products made from these mineral fibres. At the same time such a melt is kind to the material of the defibring unit.

Moreover, the relatively huge Al₂O₃ moiety in some of the combustion residues allows the substitution of other aluminium oxide supports. The aluminium oxide itself favours the biosolubility of the mineral fibres. Ashes from the combustion of lignite and coal dust as well as paper sludge and wood chips turned out as particularly suitable.

In addition to the above-mentioned effects on a method according to the invention for preparing a mineral melt for the production of mineral fibre articles the method according to the invention offers the advantage that the combustion residues that otherwise would have to be dumped can now be physically exploited.

The materials contained in the combustion residues partly have a glass-forming effect and otherwise a glass-transforming effect. Very important is that through the controlled manufacturing process components of the combustion residues which are actually undesired are integrated in the glasses in a sparingly soluble form.

Besides the advantage of the combustion residues that is actually striven for in the production of mineral fibres, this form of exploitation additionally reduces environmental load. This even applies in a case where after the end of their useful life the mineral fibres are not recycled again but instead dumped.

Further important is that normally such combustion residues may be obtained cost-free, so that the production costs of such mineral fibre products are considerably lowered.

Due to their extra-fineness and chemical composition the above-described combustion residues, particularly filter ashes for example from fluidized-bed combustion processes that occur in the combustion of lignite and/or coal dust, paper sludge or wood chips, have properties which are favourable for the production of moulded pieces concerning the strength formation of the moulded pieces. At the same time they have a positive effect on the fusion behaviour of these moulded pieces in the preparing of a mineral melt and offer a possibility of purposefully controlling the viscosity of the mineral melt. Finally, these combustion residues make a positive contribution to the improvement of the biosolubility of the mineral fibre products that are made from these mineral melts.

Further advantages and features of the invention will become apparent from the subclaims as well as from the following examples of a preferred embodiment of a method according to the invention.

According to a first example of the embodiment of the invention there are compacted moulded pieces which consist of 38 to 64% by weight of industrial residual materials, 5 to 20% by weight of melting chamber granulates, 0 to 11% by weight of converter slag, 0 to 14% by weight of foundry ladle slag as correction materials, 10 to 25% by weight of Al₂O₃ supports, for example bauxite, 9 to 12% by weight of cements as well as 1 to 5% by weight of ashes from the combustion of paper sludge. In this composition particularly the converter slag and foundry ladle slag moieties as well as the cement moieties are reduced as compared to a corresponding composition of moulded pieces according to prior art. Therefore, this embodiment results in a considerable reduction of the cement moiety, leading to a considerable reduction of the production costs of the moulded pieces.

According to a second example it is provided that deviating from the first example the correction materials are contained in the composition of the moulded pieces as follows:

| | |
|---|---|
| melting chamber granulates | 5 to 18% by weight |
| converter slag | 0 to 10% by weight and |
| foundry ladle slag | 0 to 16% by weight. |

Instead of the ashes from the combustion of paper or paper sludge this composition provides the use of 1 to 5% by weight of ashes from the combustion of wood. In this example, too there is provided a considerable reduction of the cement moiety, so that also in this case the above-mentioned effect is obtained in the cost-saving.

Finally, a further example provides that there are again mixed industrial residual materials at a percentage of 38 to 64% by weight, with a melting chamber granulate moiety of 0 to 15% by weight, converter slag moiety of 0 to 15% by weight and foundry ladle slag moiety of 0 to 18% by weight as correction materials, and an Al₂O₃ support, for example bauxite, at a percentage of 5 to 20% by weight together with 11 to 13% by weight of cement and a percentage of 5 to 25% of ash from lignite and/or coal dust combustion. In this example, too a raw material substitution by the ash takes place which is accompanied by a reduction of the cement moiety.

In the examples the correction materials are at least partially substituted by granular combustion residues, namely ashes from the lignite/coal comubustion, sewage sludge combustion, wood combustion or paper production. This results in a reduction of the required amount of cement as an expensive bonding agent and in an improved viscosity control.

1. Method for preparing a mineral melt for the production of mineral fibres, in particular rock wool for the production of insulating materials for thermal, acoustical and fire protection, of stock culture substrates, reinforcement fibres and fibres for filtering purposes, in which method at least industrial residual materials as well as correction materials for regulating the required composition and viscosity of the melt are reduced in size and compacted together with a bonding agent to form moulded pieces and are supplied to a melting unit,
characterized in
that the components of the moulded pieces, particularly the correction materials and/or other components of the mechanical mixture are at least partially substituted by granular combustion residues, in particular ashes or slags from the combustion preferably of lignite and/or coal dusts, paper sludge or wood chips.

2. Method according to claim 1,
characterized in
that said residual materials consist of solidified melts, separated spherical or spiky glass particles and/or defective or recycled products, filter dusts from the manufacturing process, mechanical mixture residues and parts of a fire-resistant furnace lining.

3. Method according to claim 1,
characterized in
that said residual materials are reduced in size and mixed with the correction materials as well as the bonding agent.

4. Method according to claim 1,
characterized in
that said moulded pieces are fed to the melting unit together with extrusive rocks like for example basalt and/or diabase and/or furnace slags.

5. Method according to claim 1,
characterized in
that said combustion residues are produced by a fluidized-bed combustion.

6. Method according to claim 1,
characterized in
that said combustion residues are fine or extra fine-grained, in particular with a grain size <0.05 mm.

7. Method according to claim 1,
characterized in
that said combustion residues have the following composition:

| | |
|---|---|
| SiO₂ | 12 to 46% by weight |
| Al₂O₃ | 8 to 20% by weight |
| TiO₂ | 0.2 to 2% by weight |
| Fe₂O₃ | 1 to 11% by weight |
| MgO | 1 to 10% by weight |
| CaO | 8 to 31% by weight |
| K₂O | 1 to 3% by weight |
| Na₂O | 0.2 to 1.5% by weight |
| SO₃ | 2 to 15% by weight |
| others | <2% by weight |

8. Method according to claim 1,
characterized in
that said moulded pieces contain inorganic bonding agents, in particular cement moieties of 9 to 15% by weight.

9. Method according to claim 1,
characterized in
that said correction materials are substituted by combustion residues to an extent of 2 to 25% by weight, in particular to an extent of 2 to 5% by weight.

10. Method according to claim 1,
characterized in
that said correction materials consist of granular ores, for example haematite or magnetite and/or residual materials from the power plant and/or metal producing and working industries and are contained to an extent of 20 to 50% by weight in said moulded pieces.

11. Method according to claim 1,
characterized in
that said correction materials have a grain size of 0 to 20 mm, in particular 3 to 7 mm.

12. Method according to claim 1,
characterized in
that said correction materials include alkaline earth materials for viscosity reduction and/or Al₂O₃ for increasing the biosolubility.

13. Method according to claim 1,
characterized in
that said combustion residues contain components from from a flue gas desulphurization.
